(19) United States
(12) Patent Application Publication
(10) Pub. No.: US 2012/0223127 A1
(43) Pub. Date: Sep. 6, 2012

(54) COMPONENTS AND METHODS OF FORMING PROTECTIVE COATING SYSTEMS ON COMPONENTS

(75) Inventors: Derek Raybould, Denville, NJ (US); Paul Chipko, Blairstown, NJ (US); Christian DelaCruz, Parsippany, NJ (US); Thomas E. Strangman, Prescott, AZ (US); Laura J. Lindberg, Tempe, AZ (US)

(73) Assignee: HONEYWELL INTERNATIONAL INC., Morristown, NJ (US)

(21) Appl. No.: 13/475,904

(22) Filed: May 18, 2012

Related U.S. Application Data
(62) Division of application No. 11/830,092, filed on Jul. 30, 2007.
(60) Provisional application No. 60/834,610, filed on Jul. 31, 2006.

(51) Int. Cl. B23K 1/20

(52) U.S. Cl. 228/256; 228/176

(57) ABSTRACT

Components and methods of forming a protective coating system on the components are provided. In an embodiment, and by way of example only, the component includes a ceramic substrate and a braze layer disposed over the ceramic substrate. The braze layer includes a silicon matrix having a first constituent and a second constituent that is different than the first constituent. The first constituent forms a first intermetallic with a portion of the silicon matrix and the second constituent forms a second intermetallic with another portion of the silicon matrix, wherein the braze layer is formulated to provide a barrier to oxygen diffusion therethrough.

### CROSS-REFERENCES TO RELATED APPLICATIONS

This application is a divisional of U.S. application Ser. No. 11/830,092, filed Jul. 30, 2007, which claims the benefit of U.S. Provisional Application No. 60/834,610, filed Jul. 31, 2006.

### TECHNICAL FIELD

The inventive subject matter generally relates to components of an air turbine engine, and more particularly relates to coating systems and methods of forming protective coating systems on the components.

### BACKGROUND

Hot section components, such as blades, bladed disks (blisks), nozzles, turbine shrouds, and combustors, made from substrates that include silicon-based (also referred to as “Si-based”) materials, such as silicon nitride (Si₃N₄), silicon carbide (SiC), and their composites, have the potential to increase the operating temperatures of gas turbine engines, as compared with components made from Ni-based superalloys. However, Si-based materials may be prone to excessive oxidation to form a silica layer, which over time may react with constituents of the substrate with which it may be in contact to and thereby become degraded. Further, silica layers of the prior art which are in direct contact with Si-based substrates continue to grow in thickness until through-thickness cracks develop, this may lead to spallation of an entire environmental barrier coating. Moreover, in the gas turbine environment, the silica layer may react with water vapor in combustion gases to form a gaseous Si(OH)₄ species. The combination of excessive oxidation of Si-based components and erosion resulting from Si(OH)₄ evaporation may lead to recession of the components, a reduced load-bearing capability, and/or a shortened lifetime.

To inhibit oxidation of Si-based components, an environmental barrier coating is typically applied over the silicon layer. Although the environmental barrier coating prevents direct exposure of the silica layer to oxygen and water vapor in the gas turbine engine environment, it has been found that the silica layer may react with constituents of the environmental barrier coating (EBC). Additionally, in some cases, the environmental barrier may still allow oxygen to diffuse, which may cause the formation of an undesirable silica layer with the substrate. As a result, the silica layer may still grow and become degraded.

Thus, it is desirable to have a high temperature (>1090° C.) oxidation barrier for Si-based gas turbine engine components. It is also desirable to have a protective coating for a Si-based substrate, wherein the protective coating includes an oxidation barrier disposed on the Si-based substrate, and an environmental barrier coating disposed on the oxidation barrier. It is also desirable to have a low cost process for forming the oxidation barrier on the Si-based component.

### BRIEF SUMMARY

Components and methods of forming a protective coating system on the components are provided.

In an embodiment, and by way of example only, the component includes a ceramic substrate and a braze layer disposed over the ceramic substrate. The braze layer includes a silicon matrix having a first constituent and a second constituent that is different than the first constituent. The first constituent forms a first intermetallic with a portion of the silicon matrix and the second constituent forms a second intermetallic with another portion of the silicon matrix, wherein the braze layer is formulated to provide a barrier to oxygen diffusion therethrough.

In another embodiment, and by way of example only, the component includes a ceramic substrate and a protective coating system. The protective coating system includes a braze layer, an environmental barrier coating, and a thermal barrier coating. The braze layer is disposed over the ceramic substrate and includes a silicon matrix having a first intermetallic and a second intermetallic dispersed throughout the silicon matrix. The first intermetallic comprises a first constituent, and the second intermetallic comprises a second constituent that is different than the first constituent. The environmental barrier coating is disposed over the braze layer, and the thermal barrier coating is disposed over the environmental barrier coating. The braze layer is formulated to provide a barrier to oxygen diffusion through the thermal barrier coating and/or the environmental barrier coating.

In yet another embodiment, and by way of example only, a method of forming a coating system on a component is provided. The method includes applying a braze mixture to a surface of the component, the braze material including silicon, a first constituent, and a second constituent that is different than the first constituent, and heating the braze mixture to form a braze layer on the component, the braze layer comprising a portion of the coating system and including a silicon matrix with a first intermetallic including silicon and the first constituent and a second intermetallic including silicon and the second constituent.

### BRIEF DESCRIPTION OF THE DRAWINGS

The inventive subject matter will hereinafter be described in conjunction with the following drawing figures, wherein like numerals denote like elements, and:

FIG. 1 is a schematic of a sectional view of a component having a braze-based protective coating, according to an embodiment;

FIG. 2 is a flow diagram of a method for forming a braze layer on a silicon-based substrate, according to an embodiment; and

FIG. 3 is a micrograph of a braze layer showing a braze layer including Si-Ta and Si-Cr intermetallics.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

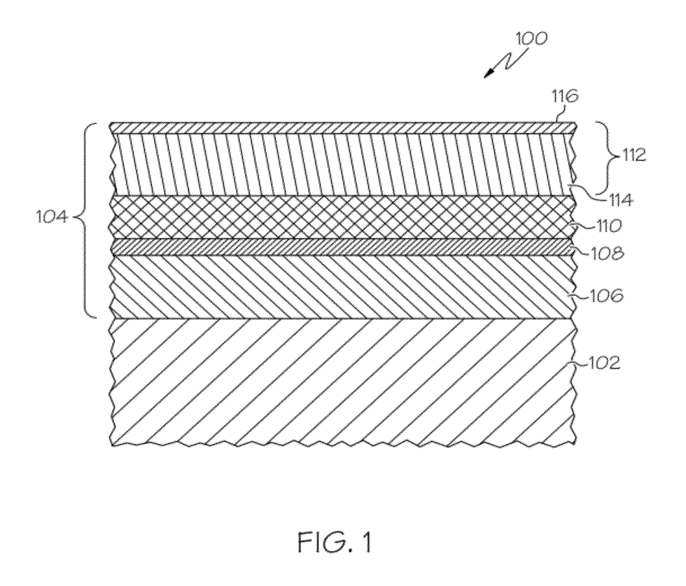

FIG. 1 is a schematic of a cross-sectional view of a silicon-based component 100, in an embodiment. The component 100 may be a gas turbine engine component that may be exposed to a high temperature environment (e.g., an integral nozzle, an integral turbine wheel, a turbine shroud, a combustor, or a blade exposed to temperatures in excess of 1100° C. (2,000° F.)) and may include a Si-based substrate 102. The Si-based substrate 102 may be made up of a silicon nitride- or a silicon carbide-based ceramic. In an embodiment, a protective coating system 104 is disposed on the Si-based substrate 102.

The protective coating system 104 may be made up of several layers. In an embodiment, the protective coating system 104 includes a braze layer 106 that may be disposed directly on a surface of Si-based substrate 102. The braze layer 106 may be formulated to prevent or inhibit the diffusion of constituents of the Si-based substrate 102 into the remainder of the protective coating system 104 and to prevent or inhibit the diffusion of oxygen therethrough. The braze layer 106 may have a thickness in the range of from about 2 to 100 microns in an embodiment, about 5 to 50 microns in another embodiment, and about 7 to 25 microns in still another embodiment.

In an embodiment, the braze layer 106 may be made up of a silicon matrix material, a first constituent, and a second constituent that is different than the first constituent. The first constituent forms a first intermetallic with a portion of the silicon matrix, and the second constituent forms a second intermetallic with another portion of the silicon matrix material. In an embodiment, the silicon matrix material may be pure silicon. The first constituent may be one or more of the elements selected from Ta, Mo, Sc, Y, and Yb. The second constituent may be one or more of the elements selected from Fe, Cr, V, Nb, Ti, Co, Hf, W, Ni, Pt, Re, and Mn. It will be appreciated that additional intermetallic-forming constituents may also be included. In such case, the additional intermetallic-forming constituents may be one or more elements selected from Ta, Mo, Sc, Y, Yb, Fe, Cr, V, Nb, Ti, Co, Hf, W, Pt, Re, and Mn. For example, a third, fourth, or even a fifth intermetallic may be formed with the additional intermetallic-forming constituents and the silicon matrix material.

It was surprisingly found to be advantageous to form more than one intermetallic in the braze layer 106. In particular, the oxidation resistance of the braze layer 106 was found to be improved over layers having a single intermetallic. Additionally, the brazability of the braze layer 106 was also found to be improved over layers having a single intermetallic, due to a wider range of acceptable temperatures and times that could be employed for brazing. In contrast, acceptable brazing temperatures and times for braze layers including a single intermetallic were narrower, which made repeatability of results more difficult.

The first and second intermetallics may be present in the braze layer 106 at a predetermined ratio. The predetermined ratio may be within a ratio range of between about 0.1:1 to 1.0:1.0, in an embodiment, and within a ratio range of between about 0.3:0.8 to 0.6:0.7, in another embodiment. In an example, the first intermetallic may be present, by volume, from about 10 to about 70%, and the second intermetallic may be present, by volume, from about 10 to about 70%. In another example, the first and second intermetallics may each be present by volume from about 30 to about 70%.

The braze layer 106 may further include additional constituents that may not form intermetallics with silicon. For example, the additional non-intermetallic-forming constituents may be added to improve a certain property of the braze layer 106. In an embodiment, the additional non-intermetallic-forming constituents may include Ag or Sn, which may be employed as a melting point depressant to thereby reduce a braze melt temperature thereof The presence of the non-intermetallic-forming constituent in the braze layer 106 may be transient. For example, the melting point depressant may be subsequently removed from the silicon by evaporation during vacuum brazing or during a post-brazing vacuum heat treatment.

Again with reference to FIG. 1, in some embodiments the protective coating system 104 may optionally further include a scale layer 108 disposed directly on the braze layer 106. The scale layer 108 may have a thickness in the range of from about 0.1 to 20 microns in an embodiment, about 0.2 to 15 microns in another embodiment, and about 0.5 to 5 microns in still another embodiment. In an embodiment, the scale layer 108 may be thermally grown by oxidation of one or more constituents of braze layer 106. The scale layer 108 may include, for example, a complex oxide derived from oxidation of an intermetallic constituent of the braze layer 106. Alternatively, or additionally, the scale layer 108 may be formed from at least one metal oxide formed by oxidation of one or more unreacted constituents of the braze mixture applied to substrate 102. For example, if free Ta is present at the surface of the braze layer 106, Ta₂O₅ may be formed in the scale layer 108. As another example, if free Si is present at the surface of the braze layer 106, the scale layer 108 may include SiO₂.

Both the scale layer 108 and the braze layer 106 may include materials that are effective barriers to the diffusion of oxygen therethrough. Thus, both the scale layer 108 and the braze layer 106 may serve as effective oxidation barriers to protect substrate 102 from excessive oxidation. As a result, the Si-based substrate 102 may be protected, by the scale layer 108 and the braze layer 106, from oxygen in the environment. Consequently, oxygen induced changes in thickness and viscosity of the scale layer 108 and the braze layer 106 can be avoided or minimized

The protective coating system 104 may further include an environmental barrier coating 110. The environmental barrier coating 110 may be disposed directly on the scale layer 108. In embodiments lacking the scale layer 108, the environmental barrier coating 110 may be disposed directly on the braze layer 106. The environmental barrier coating 110 may serve as a barrier to inhibit water vapor from reacting with the SiO₂ or Si₂ON₂ constituents of the scale layer 108 and forming volatile Si(OH)₄ within the protective coating system 104.

The environmental barrier coating 110 may be formed from, for example, Ta₂O₅ or AlTaO₄. In an embodiment, the environmental barrier coating 110 may be formed from at least about 50 mole % AlTaO₄, and the balance may be formed from at least one oxide of an element selected from the group consisting of Ta, Al, Hf, Ti, Zr, Mo, Nb, Ni, Sr, Sc, Y, Mg, Si, and the rare earth elements including the lanthanide series of elements. In another embodiment, the environmental barrier coating 110 may be formed from a silicate or disilicate, preferable based on Y, Yb or Sc. The environmental barrier coating 110 may have a coefficient of thermal expansion (CTE) in the range of from about 2 to 7×10⁻⁶ ° C⁻¹, and usually about 3.5 to 5×10⁻⁶ ° C⁻¹. The environmental barrier coating 110 may have a thickness in the range of from about 5 to 500 microns. A suitable environmental barrier coating for a Si-based component is described in U.S. Pat. No. 7,115,319, the disclosure of which is incorporated by reference herein in its entirety.

The protective coating system 104 may still further include a thermal barrier coating 112 disposed directly on the environmental barrier coating 110. The thermal barrier coating 112 may serve as a barrier to heat, as well as to prevent or inhibit the ingress of particulates or corrosive materials into the environmental barrier coating 110, thereby protecting underlying layers of the protective coating system 104 and the substrate 102 from heat and corrosive materials. The thermal barrier coating 112 may include at least one segmented columnar ceramic layer 114. The segmented columnar ceramic layer(s) 114 may comprise a stabilized zirconia or a stabilized hafnia, such as cubic yttria stabilized zirconia or cubic yttria stabilized hafnia. The interface between the environmental barrier coating 110 and the thermal barrier coating 112 may be either compositionally discrete or graded.

The thermal barrier coating 112 may further include an outer, continuous, non-columnar sealant layer 116 disposed directly on the segmented columnar ceramic layer 114. The sealant layer 116 may comprise a cubic stabilized zirconia or a cubic stabilized hafnia, such as cubic yttria stabilized zirconia and cubic yttria stabilized hafnia. The sealant layer 116 prevents penetration of extraneous materials into segmentation gaps (not shown) between columns of the segmented columnar ceramic layer(s) 114. The thermal barrier coating 112 may have a thickness in the range of from about 1 to 60 mils. A suitable thermal barrier coating 112 for a component is described in U.S. Pat. No. 7,150,926, the disclosure of which is incorporated by reference herein in its entirety.

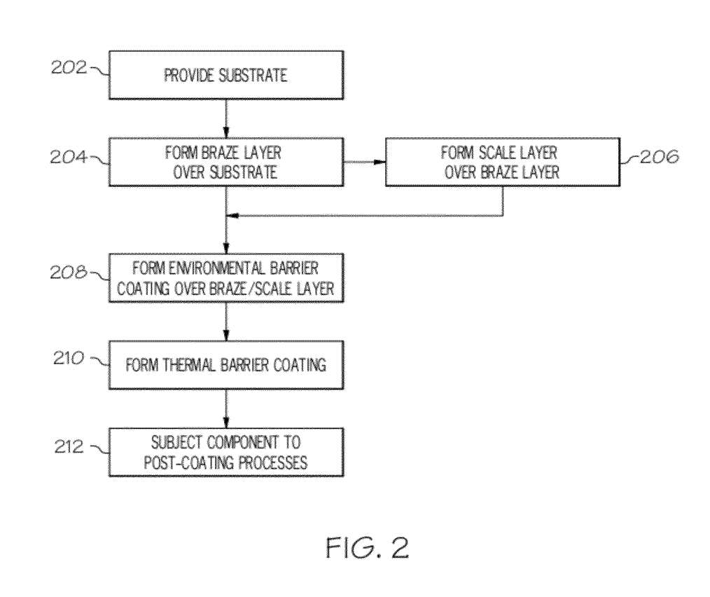

FIG. 2 is a flow diagram of a method 200 for forming a protective coating system 104 on a Si-based substrate 102, according to an embodiment. In an embodiment, a Si-based substrate 102 may be provided, step 202. The Si-based substrate may be formed from a silicon nitride- or silicon carbide containing ceramic. Next, a braze layer 106 may be formed on the Si-based substrate 102, step 204. A scale layer 108 may be formed on the braze layer 106, step 206. An environmental barrier coating 110 may be formed over the braze layer 106, or, if included, the scale layer 108, step 208. A thermal barrier coating 112 may then be formed over the braze layer 106, or environmental barrier coating 110 if included, step 210. The component may be subjected to post-coating processes, step 212. Each of these steps will be discussed in detail below.

As mentioned above, a braze layer 106 may be formed on the silicon-based substrate 102, step 204. In this regard, a braze mixture may be prepared that includes silicon (Si metal) powder, in admixture with a first constituent selected from Ta, Mo, Sc, Y, or Yb, and a second constituent selected from selected from Fe, Cr, V, Nb, Ti, Co, Hf, W, Ni, Pt, Re, and Mn. In an embodiment, the braze mixture may comprise a mixture of silicon (Si metal) powder and a first constituent such as Ta, Mo, Sc, Y, and Yb, and a second constituent such as Fe, Cr, V, Nb, Ti, Co, Hf, W, Pt, Re, or Mn, wherein the mixture of Si and the first and the second constituents may comprise a eutectic mixture. In another embodiment, the braze mixture may comprise a mixture of silicon powder having an excess of one of the first and the second constituents as compared with the amount of Ta, Mo, Sc, Y, Yb, Fe, Cr, V, Nb, Ti, Co, Hf, W, Pt, Re, or Mn present in a corresponding eutectic mixture of Si and the first and the second constituents. In still other embodiments, the braze mixture may have an excess of Si, such that free Si remains after formation of the first intermetallic and the second intermetallic by reaction of the braze mixture to form the braze layer.

In one example, the braze mixture may comprise Si metal powder, tantalum (Ta) powder as the first constituent, and chromium (Cr) powder as the second constituent. Here, Ta and Si react to form the first intermetallic, and Cr reacts on the remaining Si to form the second intermetallic. In this way, substantially all of the Si of the braze layer 106 may form part of at least one intermetallic and thus, is prevented from reacting with any oxygen with which it may contact.

In other embodiments, various additives or dopants may also be included in the braze mixture, e.g., to change the braze temperature of the braze mixture without preventing the formation of the intermetallics. Additionally, although the formation of the first and second intermetallics may primarily involve the reaction of the first and the second constituents with Si metal provided in the mixture, additional reaction of constituents with Si from the Si-based substrate may also occur under the inventive subject matter.

The braze mixture may be deposited on the Si-based substrate. The surface of the Si-based substrate may be prepared (e.g., by cleaning with isopropanol), and the braze mixture may be mixed with a binder. The binder material may be a commercially available product, such as Nicrobraze Cement #520 (The Wall Colmonoy Corporation, Madison Heights, Mich.). The braze mixture may be applied to the surface of the Si-based substrate in an amount sufficient to provide a braze layer of the desired thickness (e.g., broadly in the range of from about 5 to 100 microns). The braze mixture may be applied to the surface of the silicon-based substrate as a dry powder or as a paste. Alternatively, the braze mixture may be applied to the Si-based substrate by a thermal spray process, such as plasma spraying or HVOF, or by a physical vapor deposition process, such as electron beam-physical vapor deposition or sputtering.

The braze mixture is then reacted to form the braze layer 106. In an embodiment, the braze mixture is heated. For example, the Si-based substrate and the braze mixture thereon may be placed in a controlled atmosphere, such as an inert gas, or in a vacuum furnace. The temperature may then be increased to initiate reaction of the braze mixture to form the first and second intermetallics in the braze layer 106. In an embodiment, the temperature may be increased at a relatively slow rate (e.g., at a rate of from about 5 to 10° C. per minute) to a first temperature over a period of a few hours, wherein the first temperature may be below the melt temperature of the braze mixture. The first temperature may be, for example, in the range of from about 10 to 100° C. below the melt temperature of the braze mixture in an embodiment, about 30 to 70° C. below the melt temperature in another embodiment, and about 40 to 60° C. below the melt temperature in still another embodiment. Thereafter, the temperature may be held at the first temperature for a period in the range of from about 5 to 30 minutes.

Subsequently, the temperature may be increased relatively rapidly to a second, higher temperature, wherein the second temperature may be at or above the melt temperature of the braze mixture. For example, the temperature may be increased from the first temperature to the second temperature at a rate of from about 2 to 8° C. per minute, over a period of from about 5 to 15 minutes. The second temperature, which may be referred to as the braze temperature, may be the melt temperature of the braze mixture. Alternatively, the second temperature may be higher than the melt temperature. The second temperature may be, for example, in the range of from about 5 to 40° C. above the melt temperature in an embodiment, about 10 to 30° C. above the melt temperature in another embodiment, and about 20 to 30° C. above the melt temperature in still another embodiment. The second temperature may be dependant on the composition of the braze mixture and the intermetallics that are formed. In an example, the second temperature may be in the range of from about 1100 to 1700° C. in an embodiment, from about 1300 to 1600° C. in another embodiment, and from about 1400 to 1500° C. in still another embodiment. At the second temperature, Si in the braze mixture may be molten and may wet the surface of the substrate. Si melts at about 1414° C., thus the second or braze temperature may be below the melting point of Si metal. The temperature may be held approximately constant at or about the second temperature for a period in the range of from about 0.5 to 30 minutes in an embodiment, about 2 to 30 minutes in another embodiment, and about 5 to 20 minutes in still another embodiment. If desired, longer times and higher temperatures may be used to evaporate excess Si, especially in a vacuum furnace.

During heating, Si may react with the first and the second constituents of the braze mixture to form the braze layer 106. In some embodiments, for example, depending on the composition of the braze mixture, the heating regime, etc., the braze layer may consist essentially of a first intermetallic and a second intermetallic. In some embodiments, the composition of the braze mixture may be selected such that the presence of a continuous molten silicon phase during step 308 is transient. Such a situation may be achieved by selecting a braze mixture containing sufficient first and second constituents, e.g., Ta and Cr, respectively, to react with substantially all of the Si powder in the braze mixture.

After the braze layer 106 is sufficiently formed, the braze layer 106 and substrate may be allowed to cool, e.g., within a vacuum furnace, to ambient temperature.

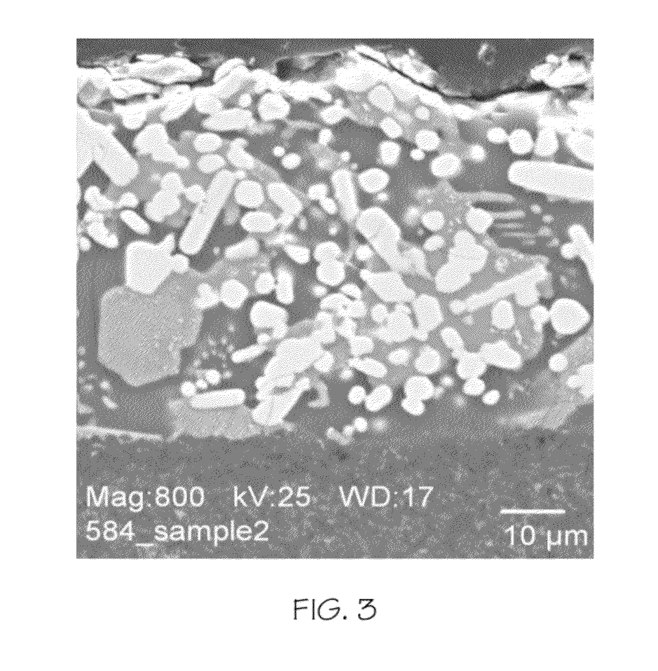

In an example in which a braze temperature of about 1450° C. is used, the heating regime or cycle of step 204 may be as follows: 1. ambient to 1385° C. in 3 hours; 2. hold at 1385° C. for 15 minutes; 3. 1385° C. to 1450° C. in 15 minutes; 4. hold at 1450° C. for 2 minutes; 5. furnace cool to ambient. It will be appreciated, however, that each of these temperatures and times, and in particular the braze temperature and the time at the braze temperature (e.g., 1450° C. for 2 minutes as cited in item 4. of the above example), may be varied depending on, for instance, the composition of the braze mixture applied to the substrate, and the desired composition of the resultant braze layer 106. A microstructure of a resultant braze layer is shown in FIG. 3. Here, Ta—Si and Cr—Si intermetallic phases are clearly visible and can be distinguished from each other by their shape and shade (e.g., Ta—Si intermetallic phase is white and Cr-Si intermetallic phase is light gray). The matrix (e.g. dark gray) is Si-rich, but also includes some Ta and Cr, which have been confirmed by elemental maps.

The scale layer 108 may be formed over the braze layer 106, step 206. In an embodiment, powdered Si metal may be applied to the surface of the braze layer to provide additional free Si for subsequent oxidation. In such an embodiment, the scale layer 108 may be formed by heating the braze layer 106 in air such that free Si in or on the braze layer 106 may be oxidized to form silica (SiO₂). In another embodiment, the scale layer 108 may be formed by oxidizing at least one constituent of the braze layer 106. In the case of Sc, Yb, and Y as constituents of the braze mixture, one or more silicates may also be formed as constituents of the scale layer, in addition to silica. For example, in the case of a ScSi-containing braze layer 106 formed from a braze mixture comprising 50 wt. % or more Si powder and Sc powder, excess free Si remains in the braze layer. The braze layer 106 may then be oxidized to form a scale layer 108 comprising scandium silicate (Sc₂SiO₅) and scandium disilicate (Sc₂Si₂O₇) in addition to SiO₂. As an example, such oxidation of the braze layer 106 may be performed by heating in air at a temperature in the range of from about 1100 to 1500° C. for a period of from about 30 minutes to 6 hours. The scale layer 108 may be formed to a thickness in the range of typically from about 0 (zero) to 20 microns in an embodiment, about 0.2 to 15 microns in another embodiment, and about 0.5 to 10 microns in still another embodiment. In yet another embodiment the scale layer may be a silicate or disilicate as a result of the SiO₂ present in the scale layer. In another embodiment, the scale layer 108 may be thermally grown. In still another embodiment, the scale layer 108 may be deposited by any one of various deposition processes, such as plasma spray coating, HVOF coating, dip coating, sol-gel coating, chemical vapor deposition, physical vapor deposition, or electron beam-physical vapor deposition. Such deposition processes are generally known in the art.

The environmental barrier coating 110 may then be formed, step 208. The environmental barrier coating 110 may be formed directly on the braze layer 106, or may be formed directly on the scale layer 108, if present. The environmental barrier coating 110 may be optional, particularly when minimal water vapor is present in the service environment. In any case, the environmental barrier coating 110 may be deposited using various deposition techniques well known in the art, e.g., by a process such as plasma spray coating, HVOF coating, dip coating, sol-gel coating, chemical vapor deposition, physical vapor deposition, or electron beam-physical vapor deposition.

The environmental barrier coating 110 may include at least about 50 mole % AlTaO₄, and the balance may comprise at least one oxide of an element selected from the group consisting of Ta, Al, Hf, Ti, Zr, Mo, Nb, Ni, Sr, Sc, Y, Mg, Si, and the rare earth elements including the lanthanide series of elements. The environmental barrier coating 110 may also comprise tantalum oxide alloyed with from about 4 to 10 mole % lanthanum oxide, or tantalum oxide alloyed with from about 1 to 6 mole % alumina. In another embodiment the environmental barrier coating 110 may be formed from a silicate or disilicate, and may be, for example, a silicate or disilicate based on Y, Yb or Sc. The environmental barrier coating 110 may be deposited to a thickness in the range of from about 5 to 500 microns. A suitable environmental barrier coating for a Si-based component is described in U.S. Pat. No. 7,115,319, the disclosure of which is incorporated by reference herein in their entirety.

The thermal barrier coating 112 may be formed, step 210. The thermal barrier coating 112 may be deposited using various deposition techniques well known in the art, e.g., by a process such as plasma spray coating, HVOF coating, dip coating, chemical vapor deposition, physical vapor deposition, or electron beam-physical vapor deposition. In an embodiment, the thermal barrier coating 112 may be formed over the environmental barrier coating 110. In another embodiment in which the environmental barrier coating 110 is omitted from the protective coating system 104, the thermal barrier coating 112 may be deposited on the braze layer 106 or the scale layer 108.

After step 210, a post-coating heat treatment may be performed, step 212. In an embodiment, the protective coating system 104 may be subjected to additional heat treatments. For example, heating may be used to induce further reaction of the melted braze mixture/incipient braze layer 106 to form one or more intermetallic phases within the braze layer 106. In another embodiment, if not already formed, a scale layer 108 may be thermally grown between the braze layer 106 and the environmental barrier coating 110 during post-coating exposure to an oxidizing environment (e.g., heat treatment or exposure to service conditions).

In an embodiment, the component 100 on which the protective coating system 104 may be formed may be attached to a second component having a protective coating system formed thereon. In this regard, the braze mixture may be used to braze the two silica-based components together into assemblies.

A high temperature (>1100° C. (2,000° F.)) oxidation barrier for Si-based gas turbine engine components has now been provided in the form of a protective coating system 104. The protective coating system 104 includes an oxidation barrier disposed on the Si-based substrate in the form of the braze layer 106 and/or the scale layer 108, and in the form of the environmental barrier coating 110 disposed on the braze layer 106. The method of forming the protective coating system may be a relatively low cost process as compared to conventional methods.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A method of forming a coating system on a component, the method comprising the steps of:
applying a braze mixture to a surface of the component, the braze mixture including silicon, a first intermetallic-forming constituent, and a second intermetallic-forming constituent different than the first intermetallic-forming constituent; and
heating the braze mixture to form a braze layer on the component, the braze layer comprising a portion of the coating system and including a silicon matrix, a first intermetallic formed by the silicon and the first intermetallic-forming constituent, and a second intermetallic formed by the silicon and the second intermetallic-forming constituent.

2. A method according to claim 1 wherein the first intermetallic-forming constituent is selected from the group consisting of Ta, Mo, Sc, Yb, and Y.

3. A method according to claim 2 wherein the second intermetallic-forming constituent is selected from the group consisting of Fe, Cr, V, Nb, Ti, Co, Hf, W, Ni, Pt, Re, and Mn.

4. A method according to claim 1 further comprising the step of forming an environmental barrier coating over the braze layer.

5. A method according to claim 1 wherein the braze mixture further comprises one or more additional intermetallic-forming constituents comprising one or more elements selected from the group consisting of Ta, Mo, Sc, Y, Yb, Fe, Cr, V, Nb, Ti, Co, Hf, W, Pt, Re, and Mn.

6. A method according to claim 3 further comprising the step of forming a thermal barrier coating over the braze layer.

7. A method according to claim 1 further comprising the step of brazing the component to another silicon-based component with the braze mixture.

8. A method of forming a protective coating system on a gas turbine engine component, the method comprising:
preparing a braze mixture comprising silicon powder and a plurality of intermetallic-forming constituents admixed with the silicon powder;
applying the braze mixture over a surface of the gas turbine engine component; and
heating the braze mixture to at least one predetermined processing temperature sufficient to react the silicon powder with the plurality of intermetallic-forming constituents and produce a braze layer over the gas turbine engine component containing a plurality of different intermetallics and providing a barrier to oxygen diffusion through the braze layer and to the gas turbine engine component.

9. A method according to claim 8 wherein the step of preparing comprises formulating the braze mixture to contain the intermetallic-forming constituents in a sufficient quantity to react with substantially all of the silicon powder during the step of heating.

10. A method according to claim 9 wherein the plurality of intermetallic-forming constituents comprises:
a first intermetallic-forming constituent selected from the group consisting of Ta, Mo, Sc, Yb, and Y; and
a second intermetallic-forming constituent selected from the group consisting of Fe, Cr, V, Nb, Ti, Co, Hf, W, Ni, Pt, Re, and Mn.

11. A method according to claim 10 wherein the second intermetallic-forming constituent comprises Cr.

12. A method according to claim 11 wherein the first intermetallic-forming constituent comprises Ta, and wherein step of preparing comprises formulating the braze mixture to contain Ta and Cr in sufficient quantities to react with substantially all of the silicon powder during the step of heating.

13. A method according to claim 10 wherein the step of preparing comprises formulating the braze mixture to contain the first intermetallic-forming constituent and the second intermetallic-forming constituent in a predetermined ratio ranging form about 0.3:0.8 to about 0.6:0.7.

14. A method according to claim 10 wherein the step of preparing comprises formulating the braze mixture such that the braze layer contains about 30% to about 70%, by volume, of the first intermetallic-forming constituent and about 30% to about 70%, by volume, of the second intermetallic-forming constituent.

15. A method according to claim 8 wherein the step of preparing comprises formulating the braze layer to include at least one non-intermetallic-forming constituent.

16. A method according to claim 15 wherein the non-intermetallic-forming constituent comprises a melting point depressant selected from the group consisting of Ag and Sn.

17. A method of forming a protective coating system on a silicon-based gas turbine engine component, the method comprising:
forming an intermetallic-containing braze layer over the silicon-based gas turbine engine component, the intermetallic-containing braze layer comprising:
a silicon matrix; and
a plurality of metallic elements bonded to substantially all of the silicon included within the silicon matrix, the plurality of metallic elements forming a plurality of intermetallics with the silicon and distributed throughout the microstructure of the braze layer to provide a barrier to oxygen diffusion through the braze layer and to the silicon-based gas turbine engine component;
forming at least one of an oxide scale layer, an environmental barrier coating, and a thermal barrier coating over the braze layer.

18. A method according to claim 17, wherein the plurality of metallic elements comprise Ta and Cr bonded to the silicon as Ta—Si and Cr—Si intermetallic phases, respectively.

19. A method according to claim 18 wherein the Ta—Si and Cr—Si intermetallic phases comprise about 10% to about 70%, by volume, of the intermetallic-containing braze layer.

20. A method according to claim 19 wherein the Ta—Si and Cr—Si intermetallic phases are present in the intermetallic-containing braze layer in a predetermined ratio ranging from about 0.1:1 to about 1.0:1.0.
